(19) United States
(12) Patent Application Publication
(10) Pub. No.: US 2009/0276317 A1
(43) Pub. Date: Nov. 5, 2009

(54) DYNAMIC INVENTORY MANAGEMENT FOR SYSTEMS PRESENTING MARKETING CAMPAIGNS VIA MEDIA DEVICES IN PUBLIC PLACES

(75) Inventors: Paul Dixon, Seattle, WA (US); Jeremy York, Bothell, WA (US); Wan-Chung William Wu, Bellevue, WA (US); Thomas C. Opdycke, Bellevue, WA (US)

Correspondence Address: PERKINS COIE LLP;PATENT-SEA, P.O. BOX 1247, SEATTLE, WA, 98111-1247, US

(73) Assignee: DS-IQ, Inc., Bellevue, WA (US)

(21) Appl. No.: 12/434,592

(22) Filed: May 1, 2009

Related U.S. Application Data
(60) Provisional application No. 61/049,622, filed on May 1, 2008.

(51) Int. Cl. G06Q 30/00

(52) U.S. Cl. 705/14.61

(57) ABSTRACT

A dynamic inventory management system and method for the identification of available inventory on a network of media devices and the optimal scheduling of campaigns, treatments, and content items on the available inventory. To optimize performance of the system, the dynamic inventory management system receives input data from a variety of sources. For example, the dynamic inventory management system receives audience metrics and campaign performance data from analytics systems, event and trigger data from event and trigger systems, and network, content, and campaign metadata from network management systems. The data received from these sources, when used in conjunction with additional rules and parameters that are received from system users, allows the dynamic inventory management system to allocate marketing campaigns, treatments, and content items to available inventory in a manner that is advantageous to both advertisers and to the network operator.

### CROSS-REFERENCE TO RELATED APPLICATION(S)

This application claims the benefit of U.S. Provisional Patent Application Ser. No. 61/049,622, entitled “DYNAMIC INVENTORY MANAGEMENT FOR SYSTEMS SUCH AS ELECTRONIC SIGNS, KIOSKS, AND OTHER MEDIA DEVICES IN PUBLIC PLACES,” filed on May 1, 2008, which is incorporated herein by this reference in its entirety.

This application describes systems and methods that can be used independently, or in conjunction with commonly assigned U.S. patent application Ser. No. 10/913,130 (SYSTEM AND METHOD FOR DELIVERING AND OPTIMIZING MEDIA PROGRAMMING IN PUBLIC SPACES), U.S. patent application Ser. No. 11/619,506 (MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES), U.S. patent application Ser. No. 12/134,992 (SYSTEM FOR SCHEDULING MARKETING CAMPAIGNS IN PUBLIC PLACES IN ORDER TO ENABLE MEASUREMENT AND OPTIMIZATION OF AUDIENCE RESPONSE), and U.S. patent application Ser. No. 12/329,497 (SYSTEM AND METHOD FOR INDEPENDENT MEDIA AUDITING AND MEDIA SERVING FOR MARKETING CAMPAIGNS PRESENTED VIA MEDIA DEVICES IN PUBLIC PLACES). These patent applications are incorporated herein by reference in their entireties.

### BACKGROUND

Many purchasing and spending decisions are made while people are shopping in a store or occupying some other public place. Advertising in stores, malls, and other out-of-home, public spaces is therefore increasingly becoming a popular media choice as more marketers shift their budget allocation away from traditional print and TV and to public locations. Effective ads that deliver relevant messages to the right customers at the right time have a huge potential to influence purchase decisions as well as build long-term brand equity for their advertisers. The use of media devices—e.g., audio speakers, video displays, kiosks and other interactive devices—promises to revolutionize out-of-home (including in-store) marketing, by providing dynamic and captivating content.

Network operators and retailers, among others, use content distribution systems to manage networks of such media devices. These content distribution systems generally provide some form of digital asset management in the form of a content registration and repository system. The content distribution systems then manage the distribution of content items from the (often centralized) content repository to a network of media players in the field—the playback devices that deliver (push, stream, etc.) content to the appropriate media devices for presentation to an audience. Content items may be assembled centrally into final display format, or distributed in component pieces, along with instructions for assembling the content into final display format on media players or media devices in the field.

A core function of such content distribution systems is to enable those individuals responsible for programming the systems to enter scheduling instructions that dictate which content items will play on which media devices, where, when, and under what conditions. The scheduling instructions may be configured through a graphical user interface, or programmed into the content distribution system more directly, for example by entering the instructions directly into an underlying relational database or through the use of some other system, software, or application, including via an application programming interface.

Such scheduling instructions may take a variety of forms. For example, the scheduling instructions may be phrased as explicit playlists, as for example when instructing a network's media devices to play content item A, followed by item B, followed by item C, in a repeating loop, for a prescribed period of time. Alternatively, the scheduling instructions may be phrased in terms of scheduling rules, which the content distribution system employs to determine which content to play where, when, and under what conditions. Such scheduling instructions may also be employed to instruct the system to, under certain circumstances, dynamically modify certain content in some prescribed fashion. U.S. patent application Ser. No. 12/134,992 provides various representations of such scheduling instructions.

The translation from scheduling instructions to scheduling execution can happen in a variety of ways. For example, the content distribution system might employ scheduling instructions in the dynamic assembly of playlists of the type whose manual creation is described above, perhaps centralizing control over media playback in a master controller. Equally, the content distribution system might transmit the scheduling instructions themselves, along with content or content components, to the media devices that comprise the network. When the scheduling instructions are transmitted to the network components for action, the instructions may be acted upon in a decentralized fashion. These are just examples; the phrasing of scheduling instructions and their implementation may readily be a hybrid or combination of these or other approaches, depending on the content distribution system and/or specific objectives in question.

Many networks of media devices are of sufficient scope and complexity that it becomes necessary for users to manage network inventory, or the aggregate opportunity for a content item to be played to be played on the network, at a higher level than the simple creation of specific scheduling instructions. For example, networks may be represented by an ad sales team or teams which sell the opportunity to have content played on the network to organizations such as third party advertisers. In this case, it will likely be desirable for the ad sales team or teams to have visibility into how much network inventory remains, (e.g., to prevent overbooking), what the remaining inventory costs, etc. These are just two examples; there are a host of other, higher-order management functions that may also be required for the successful operation of a network. One of the challenges facing ad sales teams, however, is the difficulty in selling all available inventory on a network. While popular advertising times and locations may sell quickly, an ad team is often faced with numerous open segments that are scattered in time, location, and desirability.

Content distribution systems such as those described above may provide limited inventory management functionality to allow ad sales teams to address the problem of scattered unsold inventory. For example, content distribution systems may report avails (remaining opportunity for content play), impose and maintain various scheduling rules or other business logic constraining how content is played on the network, and so on. Traditionally, however, such content distribution systems provide no more than voluminous reports of advertising timeslot availability. The lack of meaningful system tools to analyze the scattered timeslots and the inability to scale as networks have grown larger have severely impacted the ability of sales teams to sell network inventory and network operators to optimize the use of network inventory. Moreover, the lack of pricing tools that can dynamically price available network inventory in accordance with characteristics of the inventory have further impacted the ability of sales teams to sell network inventory. It would therefore be useful to make inventory management functions that are dynamic and data-driven, i.e., to drive inventory management decisions with data describing the performance of the network and the effectiveness of the various content and campaigns running on the network in engendering a desired audience response.

### BRIEF DESCRIPTION OF THE DRAWINGS

FIG. 1 is a block diagram depicting an environment in which a dynamic inventory management system operates.

FIG. 2 is a block diagram illustrating various inputs to and outputs from the dynamic inventory management system.

FIG. 3 is a block diagram illustrating individual modules that are contained in the dynamic inventory management system.

FIG. 4A is a block diagram of an inventory parameterization module for defining and parameterizing inventory types and inventory commitment types in order to provide the granular scheduling commitments.

FIGS. 4B and 4C are representative data tables containing inventory data, such as may be used by the inventory parameterization module.

FIG. 5 is a block diagram illustrating an inventory avails module for calculating and reporting avails (the available quantity of inventory for some or all of a set of inventory types and inventory commitment types).

FIG. 6 is a block diagram illustrating an inventory rate card generation module for calculating and/or reporting rate cards.

FIG. 7 is a block diagram illustrating a scheduling module for the automated generation of scheduling instructions.

FIGS. 8A and 8B are graphical depictions of available inventory for a network and a multi-phase scheduling process implemented by the scheduling module to assign treatments to the available inventory.

FIG. 9 is a flow diagram illustrating a process for translating scheduling instructions made at the level of treatments and inventory types to specific sets of operator-based instructions for manipulating a playlist.

### DETAILED DESCRIPTION

A dynamic inventory management system and method for the identification of available inventory on a network of media devices and the optimal scheduling of campaigns, treatments, and content items on the available inventory is disclosed. “Inventory” means the opportunity for a content item to be presented to an audience on the network of media devices. To optimize the use of inventory, the dynamic inventory management system receives input data from a variety of sources. For example, the dynamic inventory management system receives audience metrics and campaign performance data from analytics systems, event and trigger data from event and trigger systems, and network, content, and campaign metadata from network management systems. The data received from these sources, when used in conjunction with additional rules and parameters that are received from system users, allows the dynamic inventory management system to allocate marketing campaigns, treatments, and content items to available inventory in a manner that is advantageous to both advertisers and to the network operator. Advertisers are better able to achieve desired advertising campaign goals, and network operators are better able to sell inventory and achieve greater utilization of the network of media devices. In short, the disclosed management system creates a dynamic, data-driven approach to inventory management across multiple networks, acting as an aggregation point to create a centrally managed virtual network and federated inventory exchange.

In some embodiments, the dynamic inventory management system contains an inventory parameterization module. The inventory parameterization module employs some or all of the input data received by the system to automatically characterize the type of inventory that is available on a network of media devices and the type of inventory commitments made against the network of media devices. By characterizing inventory types and inventory commitment types, the parameterization module allows the dynamic inventory management system to determine how to best match campaigns, treatments, and content items to unused inventory across the network of media devices. In the context of a network of media devices, “inventory type” in broadest terms means the aggregation of inventory (i.e., the opportunity for a content item to be presented to an audience) into sets.

In some embodiments, the dynamic inventory management system contains an inventory avails module. The inventory avails module determines inventory available for a particular time period and inventory type by calculating a gross available inventory (taking into account deterministic and/or stochastic inventory) and removing inventory that may already be committed or which may not be expected to reach an expected performance level. The resulting avails reflect the available inventory that meets the specified type and time requirements.

In some embodiments, the dynamic inventory management system contains an inventory rate card generation module. The inventory rate card generation module calculates a rate for the available inventory, based on factors such as the network size, network characteristics, past or expected campaign performance, demand, time until presentation of the campaign, etc.

In some embodiments, the dynamic inventory management system contains a scheduling module. The scheduling module receives as input information from the inventory parameterization module, industry avails module, and inventory rate card generation module, and automatically generates scheduling instructions that seek to allocate inventory to campaigns, treatments, and content items in an optimal fashion.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention. Note that references in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

### I. Dynamic Inventory Management System

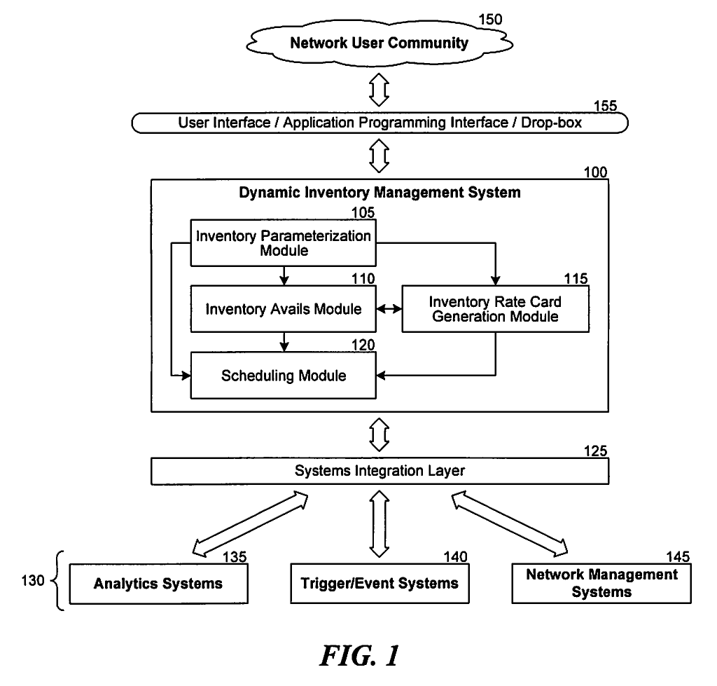

FIG. 1 depicts an environment in which a dynamic inventory management system 100 operates. The dynamic inventory management system operates in conjunction with a network of media devices, and coordinates the allocation of inventory available on the network of media devices to campaigns, treatments, or content items. In this context:
“Content item” means a specific piece of media. “Content” is one or more content items. The actual form taken by content items is dependent on the media devices that are contained in the network. For example, content items might refer to video clips played on video monitors, audio clips played over speakers, video loops played on kiosks or other interactive devices (also called “attract loops”), text messages that are presented on mobile devices, and so on.
A “treatment” is a set of one or many content items. A treatment may also include specific business rules governing or constraining the play of the set of content item(s) on the network of media devices. A treatment may also include, as another part of its definition, the inventory types and inventory commitments made to the content items contained in the treatment. For example, a treatment might be defined as Content Item A running on a checkout channel (i.e., a channel near a checkout location), with Content Item B not playing on any devices in the same store at the same time. An alternate treatment might be defined as Content Item A running on the checkout channel while Content Item B is playing on the pharmacy channel.
A “campaign” is a set of treatments to be executed for a prescribed or open-ended period of time, in furtherance of one or many specific business objectives. In addition to the set of treatments that form a campaign, a campaign may be associated with other metadata such as the campaign's name, flighting details, business rules and objectives, etc.
“Inventory” means the opportunity for a content item to be presented to an audience, and is thus also idiosyncratic to the specific media devices and content items in question. For example, “inventory” might mean the opportunity for a video clip to run on a monitor, the opportunity for an audio clip to play over a sound system, the opportunity for a particular attract loop to be displayed on a kiosk or other interactive device, the opportunity for a text message to be sent to a mobile phone, etc. A unit of inventory is a particular opportunity for a content item to be presented on a specific media device.
   The inventory management system 100 generally attempts to achieve certain desired outcomes (such as minimizing advertising spend, increasing sales of products featured on the network, etc.), within the constraints of business rules (e.g., inventory commitments made to particular campaigns, best practices governing the utilization of the network of media devices, etc.) To accomplish the desired outcomes, the dynamic inventory management system 100 may include four modules, namely an inventory parameterization module 105, an inventory avails module 110, an inventory rate card generation module 115, and a scheduling module 120. Each of these modules will be discussed in turn herein.

The dynamic inventory management system 100 may be integrated via a systems integration layer 125 with a number of analysis and control systems 130. For example, the management system may be integrated with one or more analytics systems 135 that analyze audience exposure data and quantify marketing campaign performance. The management system may be integrated with one or more trigger/event systems 140 which record external event data for correlation with the performance of marketing campaigns. The management system may further be integrated with one or more network management systems 145, which control the distribution of marketing campaigns and content items to a network of media devices. The network of media devices may be a unitary network or a collection of networks operated by one or more parties. All of the data that is generated by the analysis and control systems may be used by the dynamic inventory management system 100 to optimize the sale of inventory and the presentation of content on media devices in order to achieve a desired outcome.

Management system users 150 access the dynamic inventory management system 100 via a user interface or API 155. The users can specify, modify, initiate, and terminate marketing campaigns in the manner described in additional detail herein. “User” means both human users of the inventory management system and, potentially, other software systems that are integrated with and leverage the functionality contained within the inventory management system.

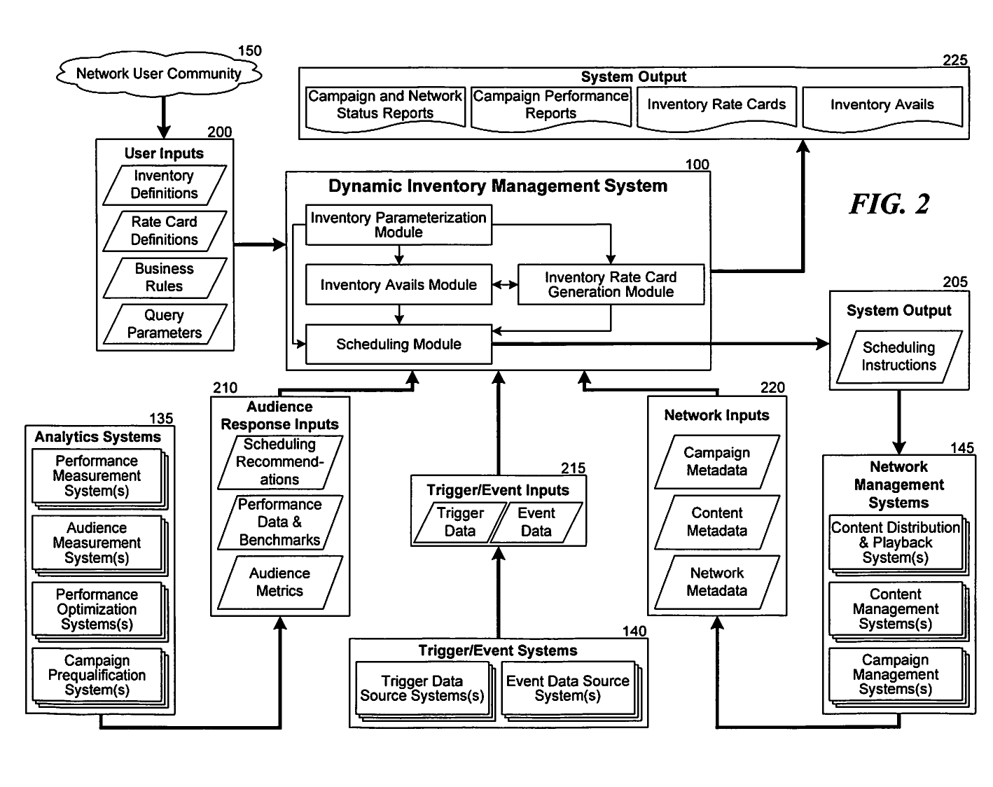

FIG. 2 is a block diagram that provides additional details about inputs provided to the dynamic inventory management system 100 and outputs generated by the dynamic inventory management system management system. The dynamic inventory management system 100 operates in the center of a virtuous loop that seeks to optimize the assignment and use of available inventory on a network of media devices. User inputs 200 are initially received from one or more members of the network user community 150. The user inputs may include, but are not limited to, inventory definitions, rate card definitions, business rules, and query parameters. “Business rules” and “query parameters” are user- or system-generated inputs that are passed into the inventory management system to constrain or guide its behavior, or to interrogate the system for status or reporting.

The dynamic inventory management system utilizes the user inputs to generate a marketing campaign or campaigns. Each marketing campaign is designed to attain at least one desired outcome explicitly or implicitly specified by the user, and is comprised of one or more treatments or content items for presentation to audiences in order to achieve that outcome. Scheduling instructions 205 (including playlists) that define a marketing campaign are output from the management system and provided to the network management system 145. The scheduling instructions are utilized to control the delivery of the content items to audiences over a network of media devices.

Feedback from the presented marketing campaigns is provided back to the dynamic inventory management system 100 via several paths. One source of feedback provided to the dynamic inventory management system is audience response inputs 210. The audience response inputs 210 are generated by the analytics systems 135, and comprise audience metrics, campaign performance data and benchmark data for comparison purposes, and scheduling recommendations for future marketing campaigns. “Audience metrics” are data that quantify the size (reach, unique reach, etc.), composition (geodemographics, gender, age distribution, behavioral clusters, etc.), and/or engagement (session time, dwell time, attention to the media, etc.) of the audience consuming media on the network or networks in question. “Performance data” refers to the impact of a campaign and its treatments or content items on the behavior of the audience consuming the media. Audience behavior can be measured or estimated in a number of ways, but at its most detailed, audience behavior consists of discrete events and the times at which those events occurred. Audience behavior events can include, for example, the following actions associated with an individual: entry into a store (perhaps as recorded by a security device, or as detected by a video camera with subsequent automated or manual processing), entry into a particular section of a store, amount of time spent in a section of the store, taking an item off the shelf and placing it into a shopping cart or basket (perhaps detected with a radio frequency identification (RFID) tag on the product and a system for tracking the location of those RFID tags), whether an individual looks at a sign (perhaps detected by a video camera located on or near the sign, with subsequent automated or manual processing), data from a user session on an interactive kiosk, data describing the viewership of a message on a mobile device, and the purchase of one or more products (data captured at a point of sale may include the product identifier, the price paid, the quantity purchased, the store identifier, the cash register identifier, a customer identifier, etc). Aggregated data for audience behavior can be used as well. Aggregated data will report how many of a certain kind of event (as described above) occurred within a given time range; the length of the time range is referred to as the aggregation period. Examples of aggregate data are units of a particular product purchased each hour per store; number of customers entering per day per store; etc.

A second source of feedback provided to the dynamic inventory management system 100 is trigger/event inputs 215. The trigger/event inputs are provided by the trigger/event systems 140, and specify particular trigger data and event data that may be correlated with the efficacy or potential efficacy of marketing campaigns that are presented to audiences. Trigger data may be, for example, data provided by weather systems about the present or future weather, public health monitoring systems, or other systems that produce actionable data. Event data may be, for example, data pertaining to store event calendars or other planning applications, interactive audience inputs, special offers offered by a competitor during a particular timeframe, etc.

A third source of feedback provided to the dynamic inventory management system is network inputs 220. The network inputs 220 are provided by the network management systems 145, and include campaign metadata, content metadata, and network metadata. The metadata provides an audit record that allows the confirmation of the presentation of campaigns at a particular time, date, and location. The metadata also indicates the dynamic inventory management system of the “health” of the network of media devices, such as technical issues that may impact the ability to use all or some of the network of media devices.

As will be discussed in greater detail herein, the inputs reflecting the campaign performance, events or other triggers, and network metadata are utilized by the dynamic inventory management system to revise and optimize the scheduling instructions 205 provided to the network management systems 145. In addition, all of the input data received by the dynamic inventory management system is utilized to output one or more reports 225 that can be acted upon by the user or other software system. The reports may include campaign and network status reports, campaign performance reports, inventory rate cards, and inventory avails.

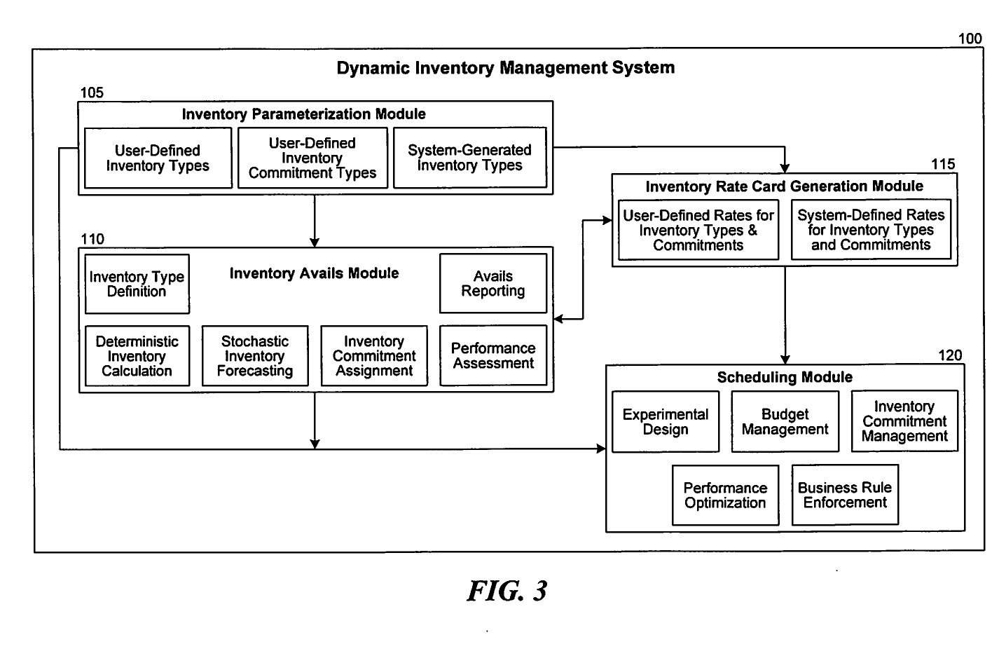

FIG. 3 is a block diagram of modules that may be contained in the dynamic inventory management system 100, namely, the inventory parameterization module 105, inventory avails module 110, inventory rate card generation module 115, and scheduling module 120. Depending on the functionality provided by the management system 100 to users, certain modules may be omitted from the system. Each module is addressed in turn herein.

### II. Inventory Parameterization Module

The inventory parameterization module 105 characterizes and quantifies inventory types and inventory commitment types to allow the dynamic inventory management system 100 to understand the characteristics of the inventory that is available across a network of display devices. In the context of a network of media devices, “inventory type” in broadest terms means the aggregation of inventory (i.e., the opportunity for a content item to be presented to an audience) into sets. Inventory types may also be referred to as “ad products,” in the case of advertisers purchasing inventory on networks. The purchase of a particular ad product may also be said to result in an “ad placement,” or simply “placement” (a term commonly used in online advertising). For example, for an in-store network of video display devices, one possible, very general “inventory type” might be termed “run of network,” meaning the inclusion of a content item in all playlists across the network. A more specific (or “targeted”) inventory type might then be “weekday afternoons,” which might (depending on the specific definition of “afternoon”) be taken to mean the inclusion of the content item in all playlists across the network, but only on Mondays, Tuesdays, Wednesdays, Thursdays, and Fridays, and only from 2:00 PM to 5:00 PM. Many other inventory types are or course possible as well, including types that are defined by geographic, demographic, or behavioral clusters of the audience consuming the media (with behavioral clustering itself perhaps based on audience response to the media), the order of precedence of content play (e.g., exclusive, priority, standard, remnant or “shoulder”, etc.), and so on.

“Inventory commitment type” means a particular choice of unit of inventory measure. There are many potential units that may be used. For example, inventory may be parameterized in terms of total screen time (i.e., for video displays), total number of times a content item is played, the percentage of time a given content item is included in the programming on the media device (e.g., store-week equivalents), impressions or audience reached by the content (e.g., reach and frequency), etc. Many other measures are possible as well. The “inventory commitment” is the obligation of the inventory management system operator to an advertiser with respect to a particular network of media devices.

To further clarify the relationship between inventory, inventory type, inventory commitment type, and inventory commitments, suppose that an advertiser has purchased the opportunity to have a thirty second video clip displayed one thousand times over the course of a month across the entirety of a particular network of video screens. In this case, the inventory being purchased is the opportunity for the video clip to be played on the network of video screens. The inventory type might be called “run of network,” as no precise targeting is being performed—the clip will be played on all the network's video screens. The inventory commitment type might be characterized as “total number of plays,” in which case the inventory commitment made to the advertiser is 1000 clip plays. Alternatively, the inventory commitment type might equivalently have been given in units of total screen time, in which case the inventory commitment to the advertiser is 30,000 screen seconds or even 500 screen minutes (one thousand plays times thirty seconds per play).

Note that for purposes of the operation of the inventory parameterization module 105, a conceptual distinction may be drawn between deterministic and stochastic inventory types. Deterministic inventory types are those whose availability can be known in advance, whereas stochastic inventory types are dependent on some external event or trigger. For example, the “weekday afternoon” inventory type described above would be considered a deterministic inventory type, as it is possible in advance to know how many weekday afternoons there will be during the course of some defined period of time. By contrast, a stochastic inventory type might be based on a triggering event such as the weather. For example, a campaign might be booked against an inventory type called “days over 90 degrees Fahrenheit,” in which case the scheduling module (see below) would only include that campaign's treatments under appropriate meteorological conditions (e.g., when the temperature was either forecast to be or actually was in excess of 90 degrees). Models can be constructed to predict in advance how many such days there will be, but those predictions can be of limited accuracy. The distinction between stochastic and deterministic can blur, particularly with respect to particular choices of inventory commitment types. For example, even though the number of weekday afternoons can be known precisely in advance, if inventory is being represented in terms of number of times the campaign's content items will play, that number is itself subject to the vagaries of such factors as the status of the physical devices that comprise the network itself. Nevertheless, the conceptual distinction between these two fundamental types of inventory remains.

Additional examples of deterministic inventory types include, but are not limited to, those based on time (e.g., hours, dayparts, etc.), geography (e.g., cities, counties, states, regions, countries, etc.), dates, (e.g., days of week, weeks of the year, holidays, seasons, years, planned events, etc.), and descriptions of the audience in question, including behavioral clusters, geodemographic clusters, life style segments, etc.

Additional examples of stochastic inventory types include, but are not limited to, those based on weather, public health indices (e.g., pollen, flu, smog, ozone, etc.), other environmental factors, triggers based on audience interaction with display devices (e.g., shopping carts, touch screens, cell phones, kiosks, etc.), supply-chain events or product stocking levels, promotions, advertisements or other media events such as TV, radio, print, coupons, etc., either by competitors or a particular advertiser, brand, or agency, current news or events, shopper loyalty programs or other forms of shopper identification, triggers based on collaborative filtering or other such algorithms used for modeling or predicting shopper behavior, outputs of interactive store search technologies (e.g., online, through mobile technologies, or deployed through in-store devices such as kiosks), physical movement of product or deployment of other in-store marketing devices (perhaps as reported through RFID technology), movement of shoppers around the store, other interactions of the network audience with mobile devices, or any other triggers or events.

For example, the inventory parameterization module 105 might define a stochastic inventory type to be those times when a potential audience member (e.g., a shopper) interrogates an interactive device with a personal mobile device, or passes within range of a local transmitter such as a femto-cell with a mobile device in a state enabling the receipt of messaging such as a text message. The stochastic inventory commitment type in question might be defined as “number of text messages sent to receiving mobile devices,” and an advertiser on the network might, for example, purchase the right to have up to a desired number of their specific messages delivered, at some fixed fee per message. Clearly, the number of messages that will be delivered can only be approximated beforehand, not known exactly, so this inventory type (delivery of a text message) and inventory commitment type (number of text messages delivered) would be classified as stochastic.

Another class of stochastic inventory type includes the notion of pay per performance. Examples of audience descriptions were given above as deterministic inventory types, including behavioral clusters, geodemographic clusters, life style segments, etc. Such segmentations lead to the formation of deterministic inventory types when they are applied a priori to segment network inventory. There is, however, an alternative or even complementary approach, which is to classify audiences based on how they respond to the content itself. For example, an advertiser on a digital media network might wish to purchase inventory that leads to the desired audience response, without any a priori modeling or segmentation of the audience itself. In some such cases, it may be desirable to manage the network inventory based not on a concept such as number of content item plays, but rather until the desired audience response is achieved (e.g., play an advertiser's content until a desired number of units of product are sold). Again, this could extend to include billing the advertiser based on an achievement of desired goals, rather than simply on how much exposure the content items received. As audience response cannot be known explicitly beforehand, this too becomes a stochastic formulation of inventory management. For example, if the advertiser had a fixed budget to spend, and was paying on performance, it would not be known in advance exactly how many content item plays the advertiser would be able to afford with that fixed budget, as the performance of the content items (i.e., the response of the audience) would not be known explicitly beforehand.

Some examples have already been given, but there are many possible choices of measures or inventory commitment types that may be employed to express inventory commitments. For example, inventory commitment types may be phrased as the total number of times a campaign's treatments will be executed in a given period of time. Alternatively, instead of the total number of plays, inventory commitments might be made in terms of the total amount of screen- or other playback device time the campaign's treatments will consume. Conversely, inventory commitment types might be phrased as the percentage of playlists a campaign's treatment will be included in over the life of the campaign, or even in terms of the total size of the audience reached by the campaign (e.g., reach and frequency). Inventory commitment types may also include other business constraints, notions of exclusivity or inclusivity, or percentage of total content item plays. Many other definitions will be readily appreciated by those skilled in the art.

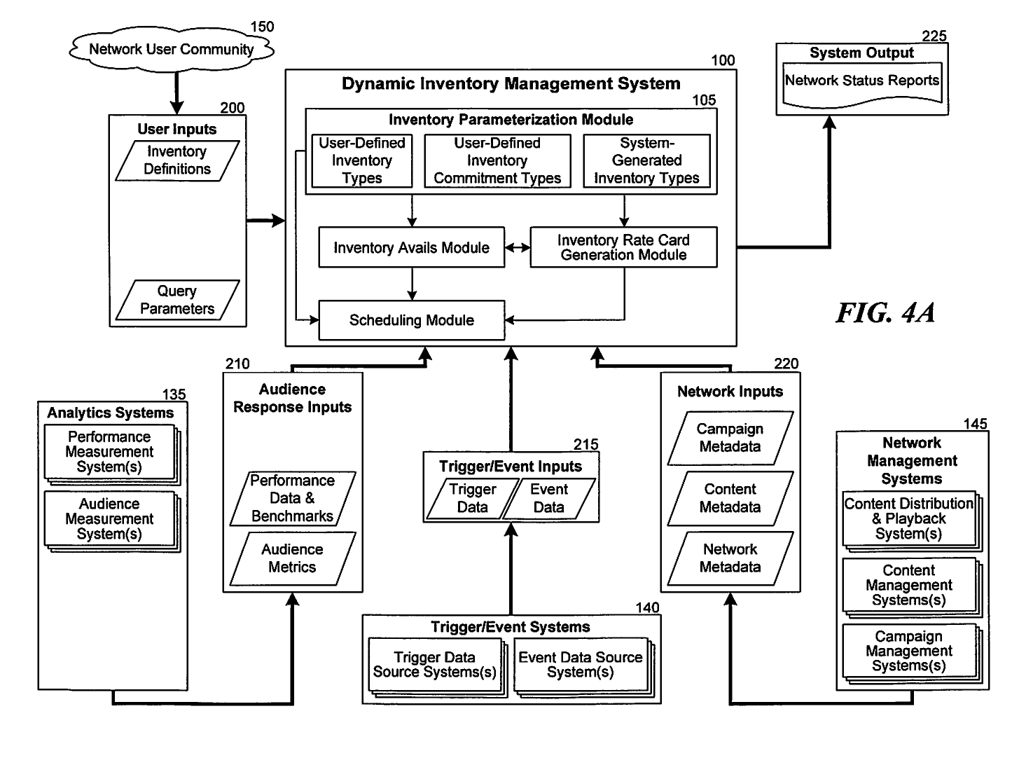

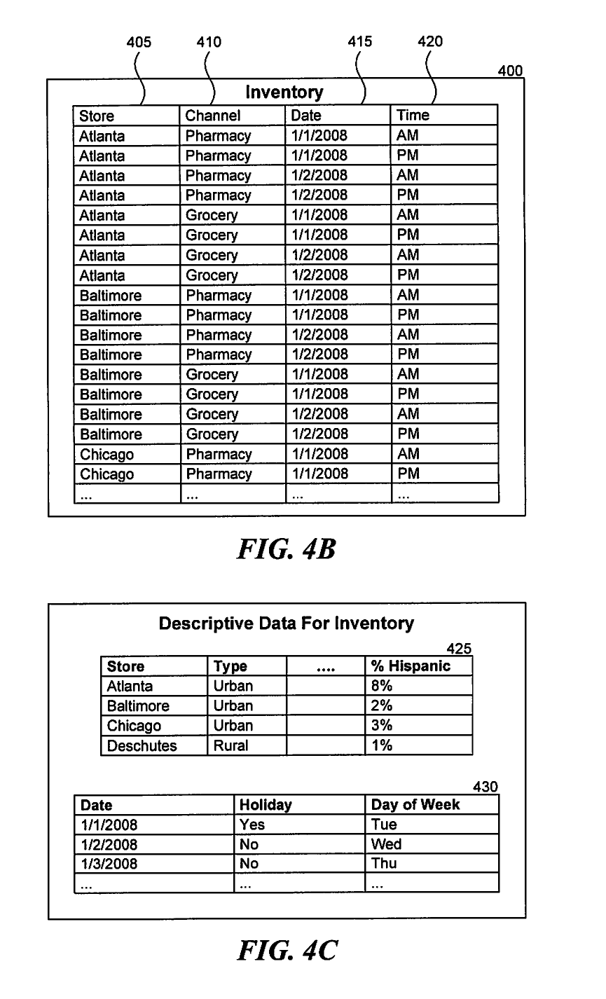

FIG. 4 is a block diagram of the dynamic inventory management system 100 with certain inputs, outputs, and connected systems highlighted that are utilized by the inventory parameterization module 105 to characterize inventory types and inventory commitment types. Depending on the particular embodiment, some or all of the particular inputs shown in FIG. 4 can be utilized; not every embodiment requires all data inputs, depending on the nature of the underlying network and the required complexity of inventory types. Other inputs that are not shown may also be used by the dynamic inventory management system to characterize the available inventory.

The inventory parameterization module 105 collects data from a number of different sources to enable it to analyze available inventory. For example, the inventory parameterization module 105 receives inventory type definitions and parameters, inventory commitment type definitions and parameters, and/or query parameters from users of the system (e.g., network programming planners, ad sales teams, store managers, etc.) via user inputs 200. Such user inputs may be received via user interfaces and/or application programming interfaces. The inventory parameterization module 105 also receives campaign performance data and audience metrics from one or many analytics systems 135. Further descriptions of performance data and audience metric data may be found in the related U.S. applications that have been incorporated by reference herein. The inventory parameterization module 105 also collects data and/or metadata from one or many trigger systems 140, such as weather systems, public health monitoring systems, or any other systems producing output data that can be used in informing or dictating scheduling decisions. Similarly, the inventory parameterization module 105 also collects event data from one or many event data source systems. Examples of event data source systems include store event calendars or other planning applications, interactive audience inputs, or various manual forms of data input. Network, campaign, and/or content metadata are collected by the inventory parameterization module 105 from one or many network management systems 145 that in whole or in part constitute the network or networks over which campaigns are being deployed. The network metadata describe such properties as the physical deployment of the media devices, their state of readiness, advance notice of any planned outages, etc. The campaign and content metadata may include, but is not limited to, existing campaign parameters, flighting details, targeting parameters, budgets, treatments and their associated metadata, including inventory commitments, inventory commitment types, content item frequencies and adjacencies, other constraining business rules, and content item file types, play times, etc.

The data collected by inventory parameterization module 105 may be stored in a database or other data structure. FIGS. 4B and 4C are representative tables that contain an example of available inventory and the metadata that is associated with that inventory. In FIG. 4B, a table 400 contains a list of available inventory in a network of media devices. The table contains four columns that characterize the inventory. A first column 405 contains a unique identifier associated with each store having deployed media devices. In the depicted example, each store is identified by the name of the city in which it is located, but other identifiers such as a unique store code may be utilized. A second column 410 indicates a particular placement of a media device within a store. In the depicted example, the placement is specified by department but other ways of specifying location may also be used (e.g., by aisle, by GPS coordinates etc.). A third column 415 and fourth column 420 specify a calendar date and time associated with each inventory period. Although the time is depicted as being divided into two periods (AM and PM), it will be appreciated that the time may be divided more finely depending on the length of the typical campaign, treatment, or content item that is operated on by the dynamic inventory management system. While four columns are shown, it will be appreciated that a greater or lesser number of columns may be provided in the table 400 to characterize the inventory. In FIG. 4C, additional tables are provided that contain metadata that further characterizes the inventory. For example, a table 425 contains location and demographic data associated with each store. The demographic data characterizes the predicted population of consumers that frequent that store. As another example, a table 430 contains known holidays that may be associated with a particular store. The representative metadata contained in tables 425 and 430 may be utilized by the dynamic inventory management system to allow more accurate inventory selection.

While FIGS. 4B and 4C depict tables whose contents and organization are designed to make them more comprehensible by a human reader, those skilled in the art will appreciate that the actual data structure(s) used by the system to store this information may differ from the tables shown, in that they, for example, may be organized in a different manner, may contain more or less information than shown, may be compressed and/or encrypted, and may be optimized in a variety of ways.

The inventory parameterization module 105 employs some or all of the input data streams (user inputs 200, audience response inputs 210, trigger/event inputs 215 and network inputs 220) to automatically define inventory types. For example, trigger data may be processed and aggregated to form system-generated stochastic inventory types. A specific example of such automated generation of inventory types might be the historical evaluation and aggregation of temperature records. In such a case, the inventory parameterization module might determine that, for a given region, an appropriate break-point for use in defining an inventory type to be named “hot days” would be a forecasted temperature of 80 degrees Fahrenheit. The derivation of such a specific breakpoint might be based on a frequency analysis of the trigger data reflecting historical weather records, with the goal of identifying a temperature that is reached or exceeded a given percentage of the time.

As another example of the automatic definition of inventory types, records of campaign performance (for example, of the kind described in detail in commonly assigned U.S. patent application Ser. No. 11/619,506 entitled “MEASURING PERFORMANCE OF MARKETING CAMPAIGNS, SUCH AS THOSE PRESENTED VIA ELECTRONIC SIGNS, SPEAKERS, KIOSKS AND OTHER MEDIA DEVICES IN PUBLIC PLACES”) are evaluated and used by the inventory parameterization module 105 to define inventory types. For example, it may be the case that certain times of day or days of the week are generally conducive to better campaign performance on average, perhaps because of underlying audience traffic patterns, or differing audience need states resulting in content items in general being more or less relevant. In such a case, it may be desirable to quantify these general trends through the use of historical campaign performance data. For example, the inventory parameterization module might seek to identify the times of global best and worst campaign performance, and use these times (days of week, parts of the day, weeks of year, seasons, etc.) to define tiers of inventory such as “premium” and “sub-premium” inventory types, analogous to notions of prime-time used in traditional media.

As yet another example of the automatic definition of inventory types, the inventory parameterization module 105 may define inventory types in the context of both the historical campaign performance and certain properties of the campaigns themselves. To make such an analysis, the parameterization module may rely upon campaign data and/or metadata received as network inputs 220 from the network management systems 145. In such cases, the parameterization module might seek to identify times where campaigns promoting certain types of products, or possessing treatments aimed at particular audience demographics, perform best. For example, it might be desirable to automatically identify times or places where campaigns targeted towards youth have historically performed well. In this case, both the historical performance data received as audience response inputs 210 and the campaign metadata received as network inputs 220 would be used in the module-generated construction of inventory types. Similar examples may be given for the utilization of event data and network data in the module-generation of additional inventory types; indeed, all of the inputs 200, 210, 215 and 220 may be used in whole or in part in this exercise.

In another embodiment, the generation of inventory types by the inventory parameterization module 105 is based in whole or in part on behavioral clustering or some other segmentation of the audience consuming the media. A host of techniques exists for creating such audience segmentations, including for example intercepts and attitudinal surveys, geodemographic surveys, historical campaign performance, etc. For example, certain audiences might be identified that tend to respond favorably to premium offerings advertised on the network, particular kinds of shows or content (e.g., cooking shows in grocery departments), price promotions, etc.

In another embodiment, the generation of inventory types by the inventory parameterization module 105 as outlined above is to a greater or lesser extent constrained by the user inputs 200. For example, the user may input the total number of inventory types allowed, some minimum quantity of inventory that must be present for an inventory type to be included by the module, inventory types that must be expressly included, inventory types that may not be included in the total allowed set, etc. When such constraints are entered by a user, the inventory parameterization module 105 restricts the defined inventory types to the boundaries that are imposed by the user.

In another embodiment, users of the inventory parameterization module 105 query the module through the user interface or application programmer interface 155 as to the state of existing inventory types and/or inventory commitment types. The module may output data responsive to the query back to the user in any variety of formats (e.g., via tabular reports, graphical reports, a web interface, a function call, etc.).

It will be appreciated that all of the functionality described in the preceding paragraphs can apply equally to a single network, or across multiple networks of media devices. In the latter case, the inventory parameterization module 105 may act as a centralization point, providing the user an automated interface to view, define, parameterize, and otherwise manage inventory types and commitments across multiple networks of media devices. For example, the inventory parameterization module may form the basis for managing inventory across a federated exchange, itself comprised of many sub-networks.

### III. Inventory Avails Module

The inventory avails module 110 calculates and reports inventory avails. In broadest terms, “avails” means the amount of a given inventory type available for assignment to a campaign, or “booking”. Avails are expressed in units corresponding to some particular choice or choices of inventory commitment type(s). Avails may be expressed in relation to a specific campaign, as when there are additional business rules idiosyncratic to the campaign that may govern the amount of inventory available. Avails may also be expressed in general terms, without regard to the specifics of any particular campaign.

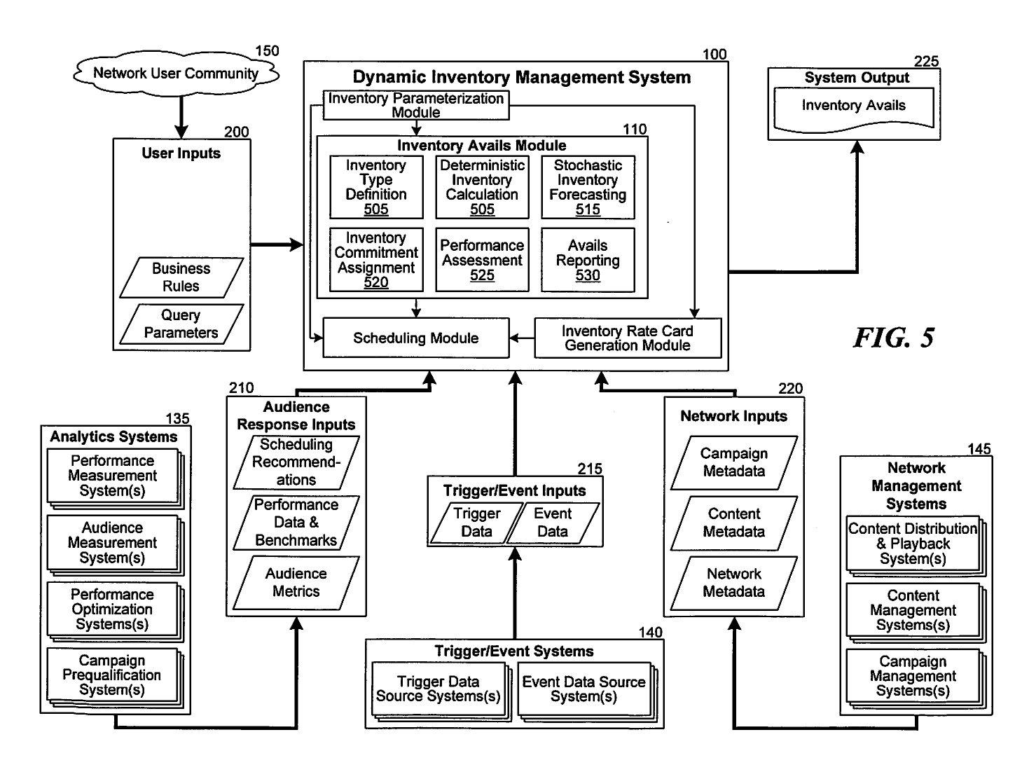

FIG. 5 is a block diagram of the dynamic inventory management system 100 with certain inputs, outputs, and connected systems highlighted that are utilized by the inventory avails module 110 to calculate and report industry avails. Depending on the particular embodiment, some or all of the particular inputs shown in FIG. 5 may be utilized; not every embodiment requires all data inputs, depending on the nature of the underlying network and the required complexity of avails reporting. Other inputs that are not shown may also be used by the dynamic inventory management system to calculate and report inventory avails.

The inventory avails module 105 collects data from a number of different sources to enable it to calculate inventory avails. For example, the inventory avails module 110 may receive business rules constraining the avails calculation process and/or query parameters from users of the system (e.g., network programming planners, ad sales teams, store managers, etc.) via user inputs 200. Such user inputs may be received via user interfaces and/or application programmer interfaces. The inventory avails module 110 may also receive campaign performance data and audience metrics from one or many analytics systems 135. Further descriptions of performance data and audience metric data may be found in the related U.S. applications that have been incorporated by reference herein. Additionally, the inventory avails module 110 also collects performance benchmarks from one or many campaign prequalification systems and scheduling recommendations from one or many performance measurement and/or optimization systems.

In addition to receiving data from analytics systems 135, the inventory avails module 110 also collects data from trigger/event systems 140. For example, the inventory avails module 110 may collect data and/or metadata from one or many trigger/event systems, such as weather systems, public health monitoring systems, or any other systems producing output data that can be used in informing or dictating scheduling decisions. Similarly, the inventory avails module 110 also collects event data from one or many event data source systems. Examples of event data source systems could include store event calendars or other planning applications, or various manual forms of data input. For convenience of description, “triggers” and “events” are distinguished as follows: triggers (e.g., weather-based triggers) are taken to be fundamentally stochastic in nature; their frequency of occurrence may be modeled in some fashion. In contrast, events (e.g., upcoming holidays, community events, etc.) are taken to be fundamentally deterministic in nature, such that their frequency and timing of future occurrence may be understood explicitly. In practice this distinction is often blurred, in particular when events themselves may or may not occur within some prescribed time frame (e.g., the outcome of a sporting event). This is a useful semantic distinction, however, for the inventory forecasting discussion that follows.

The inventory avails module 110 may also receive network, campaign, and/or content metadata from one or many network management systems 145 that in whole or in part constitute the network or networks over which campaigns are being deployed. The network metadata may describe the past, current, and/or future planned state of the network, such that the avails system has visibility into the number, deployment details, status, etc., of the media playback devices that constitute the network or networks. Finally, the inventory avails module 110 may collect campaign and/or content item metadata from one or many campaign management systems. The campaign and content metadata may include, but is not limited to, existing campaign parameters, flighting details, budgets, treatments and their associated metadata, including inventory commitments, inventory commitment types, content item frequencies and adjacencies, other constraining business rules, and content item file types, play times, etc. The following Table 1 presents representative campaign and content metadata including, for example, associated data for commitment type, commitment, and inventory type:

TABLE 1

| | Campaign ID, | Commitment | | Content | | |
|---|---|---|---|---|---|---|
| Category | Content ID | Type | Commitment | Length | Inventory Type Details | |
| User- | 1, A | Screen Time | >30 mins/ | 0:15 | Run of | |
| Defined | | | store day | | Network | |
| User- | 2, B | Play Count | >10,000 | 0:30 | Weekday | |
| Defined | | | plays/month | | 12:00-19:00 | |
| User- | 3, C | Screen Time | >30 mins/ | 0:30 | Friday after | Mid- |
| Defined | | | store day | | 18:00; | Atlantic |
| | | | | | Weekends | region |
| User- | 3, D | Screen Time | >30 mins/ | 0:30 | Friday after | Stores |
| Defined | | | store day | | 18:00; | with Drive- |
| | | | | | Weekends | Thru |
| | | | | | | Pharmacy |
| User- | 4, E | Play Count | >1,000 plays/ | 1:00 | June 28- | Rural |
| Defined | | | store week | | July 4 | Stores |
| System | 5, F | % of Available | 20% | 0:20 | Days with | Stores |
| Generated | | Inventory | | | projected | with % |
| | | | | | temperature | Hispanic |
| | | | | | >80° F. | over |
| | | | | | | threshold |
| System | 6, G | Messages | 10,000 | N/A | Shoppers | |
| Generated | | Sent | | (content is | requesting | |
| | | | | a text | electronics | |
| | | | | message | product | |
| | | | | sent to | information | |
| | | | | shopper's | from Kiosk | |
| | | | | cell phone) | | |
| System | 7, H | Impressions | 50,000 | 1:00 | Football | Stadium |
| Generated | | | | | Game Half- | Menu |
| | | | | | time and | Boards |
| | | | | | Timeouts | |
| System | 8, I | % of Available | 25% | 1:00 | Dates, Times | |
| Generated | | Screen Time | | | and | |
| | | | | | Locations in | |
| | | | | | which | |
| | | | | | customers | |
| | | | | | most likely to | |
| | | | | | shop for | |
| | | | | | HDTV | |
| System | 9, J | Total Ad | Not to | 0:45 | Behavioral | |
| Generated | | Budget (Pay | exceed | | clusters | |
| | | For | $50,000 | | which score | |
| | | Performance | | | highest on | |
| | | ad model) | | | likelihood of | |
| | | | | | positive | |
| | | | | | response | |

Finally, as illustrated in FIG. 5, the inventory avails module 110 also receives inventory metadata from the inventory parameterization module 105. The inventory metadata is characterized by the inventory parameterization module to enable the inventory to be appropriately utilized.

The inventory avails module 110 executes six component processes, namely an inventory type definition process 505, a deterministic inventory calculation process 510, a stochastic inventory forecasting process 515, an inventory commitment assignment process 520, a performance assessment process 525, and an avails reporting process 530. Not all of the processes may be executed when calculating and reporting inventory avails; depending on the requested inventory types and time period of inventory avails, some subset of these component processes may be executed, and the order of process execution may vary as well. Further, these processes may be executed sequentially, or some or all of them may be executed simultaneously. For example, linear programming or some other form of constrained optimization may be employed in the avails calculation process, which might combine certain of these conceptually distinct processes into a single execution step.

The avails calculation and reporting process begins with the inventory type definition process 505, which identifies the inventory types and future time period for which avails reporting is required. The future time period may be specified as a desired start time of a campaign and a stop time of a campaign, as a desired start time of a campaign and a length of campaign presentation (e.g., fixed, open-ended, contingent period, etc.), as a calendar period (e.g., the month of June), or any method of specifying time. Query parameters which specify a desired set of inventory types and/or reporting time periods may be received from a user, either through a user interface, application programmer interface, or some other means. Alternatively, the inventory type definition process may be executed in a default fashion based on system-specified settings (i.e., using default settings to perform a monthly calculation of avails associated with a particular network) without such user-provided specificity.

Once the inventory types and time periods for avails reporting are defined by the user or by the system, the deterministic inventory calculation process 510 calculates the gross available inventory for those inventory types that are deterministic in nature. For example, the user may query the system to return avails for weekday afternoons for the next month, across the entire network. In this context, “gross available inventory” means net of existing commitments and other constraints, so in the example just given, the gross available inventory calculation would be simple, dependent only on the specific definition of “afternoon”—itself a property of the inventory type, as described above. More complex examples of deterministic inventory types might include subsets of the network (specific sets of playback devices or channels, more complex date or dayparts, etc.), or inventory types with more specific requirements for particular content items (i.e., spots of a given duration, or with a desired frequency, or in the context of campaigns with other, potentially campaign-specific business rules, such as “this campaign's treatments may not be included in the same play list as some other campaign's treatments”). Additional examples might include various audience segmentations or parameterizations, as discussed above (e.g., audiences that respond well to particular types of content such as cooking shows, audiences with particular geodemographic properties, etc.).

Following calculating of the gross available inventory that is deterministic in nature, the stochastic inventory forecasting process 515 then calculates the predicted gross available inventory (again net of existing commitments and other constraints) for inventory types with a stochastic component. A variety of different forecasting algorithms may be utilized in by the stochastic inventory forecasting process. For example, if the inventory type in question were “days where the temperature exceeds 90 degrees in temperature,” the forecasting problem might be approached by employing a very complicated meteorological model, or much more simply, through the use of historical averages (perhaps as inferred from trigger data). Though there is a wide body of time series and other forecasting techniques that may be used by the stochastic inventory forecasting process, the result of the calculation is the same: a predicted quantity of gross future inventory for inventory types with a stochastic component.

To this point, the inventory avails module 110 has calculated a gross avails number based on the inventory type definition as applied to the available deterministic and stochastic inventory. Next, the inventory commitment assignment process 520 decrements the calculated value to reflect existing inventory commitments (if necessary; there may not be any). Conceptually this can be thought of as an allocation problem: if existing commitments have been made, the inventory avails module should understand what those commitments are and how they have been represented, such that it can accurately reflect them in the avails calculation. Accounting for existing commitments helps to prevent over-booking. The allocation analysis performed by the inventory commitment assignment process may be more or less static or dynamic. For example, inventory commitments may be entirely rigid, possessing a strict assignment of inventory that must be made to satisfy the commitment, as when a campaign's treatments must be included at a certain future time on a certain media device. Alternatively, inventory commitments may be quite flexible, as when a campaign's treatments must be included on some percentage subset of the total media devices, without specifying precisely which devices must be chosen. The allocation analysis performed by the inventory commitment assignment process may in fact treat flexible inventory commitments in a more rigid fashion (i.e., treating potential inventory commitments as having indeed been committed), leading to some loss of flexibility in future scheduling decisions, but it should not treat rigid inventory commitments in an inappropriately flexible fashion, as subsequent under-delivery against inventory commitments (i.e., overbooking) could result.

After modifying the gross avails to remove existing inventory commitments, the performance assessment process 525 assesses a campaign's expected performance. As mentioned above, not all of the depicted processes are executed by the inventory avails module 110. When the performance assessment process 525 is executed, however, avails become campaign-specific, and are calculated in the context of a specific expectation of future performance. The expected performance of a campaign may be determined in a variety of ways (e.g., by comparing a given campaign with analogous campaigns with similar properties, by evaluating the given campaign's own performance history, or more generally, where the expected performance is simply provided as an input to the system, perhaps directly from the user). In any case, the result of executing the performance assessment process 525 is potentially to adjust the gross avails number to reflect just that inventory on which the expected performance is deemed adequate for the campaign or campaigns to be included on the network. The adjustment typically performed as a result of the performance assessment process 525 is to reduce the avails. In other words, the avails calculation may not return all of the theoretically available inventory, if the performance assessment process determines that the campaign's expected performance cannot justify its booking against all of that inventory (e.g., that the network is better served by excluding the campaign from some inventory, leaving it available for some other campaign to consume). One skilled in the art will appreciate, of course, that the inventory avails module might equally work the problem from the other direction, beginning with the assertion that no inventory is available, and only adding inventory into the avails estimate if the campaign's expected performance exceeding various threshold values. Such thresholds might, for example, be based on expected sales lift of featured items, products or services, sales lift of items of the same category as those featured in the campaign, marginal rate of return of the campaign, etc.

Finally, once the gross avails have been modified to account for campaign performance, the resulting avails calculations are prepared for delivery by the avails reporting process 530. The avails reporting process may format the avails into appropriate reports or data formats for delivery to the user or users, or as inputs to another system.

### IV. Inventory Rate Card Generation Module

The inventory rate card generation module 115 calculates and reports inventory rate cards. “Rate cards” are pricing guidelines or rules associated with inventory types and inventory commitment types. Rate cards may be manually defined, system generated, or a combination of the two. For example, a rate card might be derived from a base price that is automatically adjusted upward for inventory reservations made further into the future (to reflect the option value of reserving inventory ahead of time). Similarly, the enforcement of rate cards may be a manual or system-driven exercise. Rate cards may be enforced more or less flexibly or rigidly, depending on many factors, such as the network, underlying business realities (e.g., whether the network is broadly oversold or undersold), other business objectives, etc. Rate cards may also be made dynamic by being based on the state of an auction or other bidding environment.

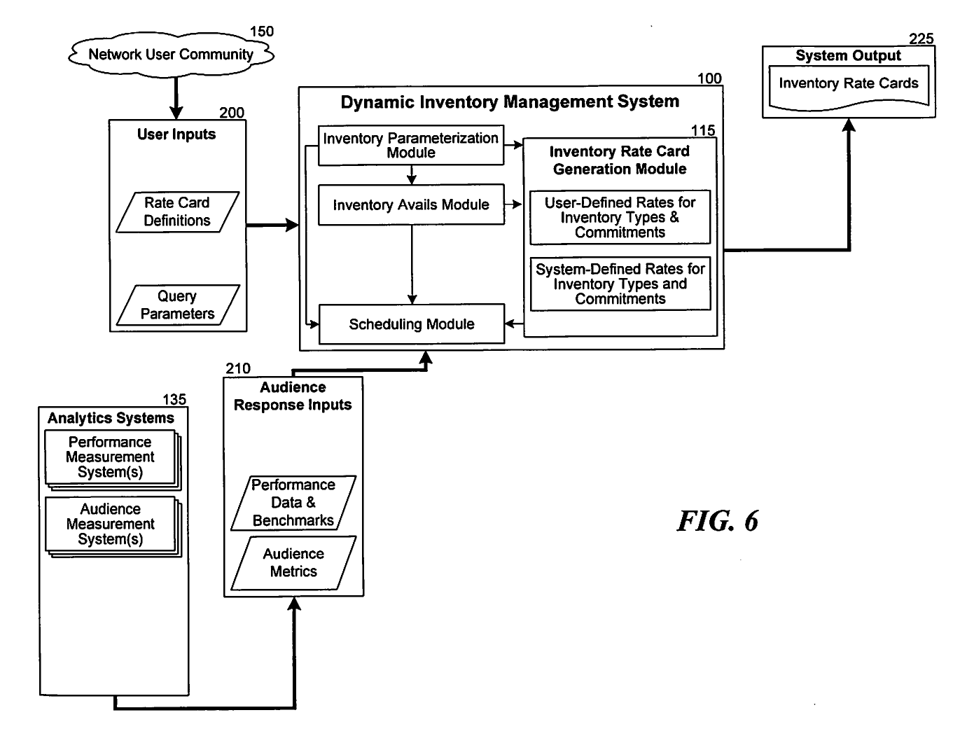

FIG. 6 is a block diagram of the dynamic inventory management system 100 with certain inputs, outputs, and connected systems highlighted that are utilized by the inventory rate card generation module 115 to calculate and report rate cards. Depending on the particular embodiment, some or all of the particular inputs shown in FIG. 6 may be utilized; the rate card generation module does not necessarily require all data inputs be present, depending on the nature of the underlying network and the required complexity of rate card reporting.

The inventory rate card generation module 115 collects data from a number of different sources to enable it to calculate and report rate cards. For example, the inventory rate card generation module may receive input pricing guidelines or rules from users for some or all combinations of inventory and inventory commitment types via user inputs 200. Such user inputs may be received via user interfaces and/or application programmer interfaces. As previously noted, “users” may themselves be other systems that communicate directly with the rate card generation module. The inventory rate card generation module 115 also collects inventory type and inventory commitment type metadata from the inventory parameterization module 105 and avails data from the inventory avails module 110. The inventory rate card generation module 115 also receives data from one or more analytics systems 135, including campaign performance data from one or many measurement systems and network audience metrics from one or many audience measurement systems or other sources of audience measurement.

The pricing guidelines or rules contained in any given rate card are calculated for some set of inventory types and inventory commitment types. In the embodiment illustrated in FIG. 6, some of the pricing guidelines and/or rules the inventory rate card generation module 115 produces may be defined manually by users of the system (e.g., either manually set or subject to manual adjustment and confirmation by a user), while other pricing guidelines or rules may be calculated automatically. In the latter case, the user may still retain control over the algorithms the module employs in the calculation of inventory parameters. For example, users may input various tuning parameters, algorithm coefficients, and other module settings as part of the user input 200 query parameters that to a greater or lesser extent dictate the module's behavior.

The automated calculation of pricing guidelines and rules by the inventory rate card generation module 115 may employ some or all of the input data described above. For example, it may be desirable for pricing guidelines to depend on the scarcity of available inventory, as when the managers of a network desire to charge a premium price for inventory types that are in short supply, or when the managers of a network wish to lower the price for inventory types for which there is an abundance. In such cases, the rate card generation module can yield higher revenue if it has visibility into inventory avails. Similarly, there are many scenarios in which network managers may desire to charge a different price for what would otherwise be the same inventory type, depending on how far in the future (or how far into the future) a campaign is booked. For example, it may be desirable to charge a premium for the privilege of booking inventory far in advance, reflecting the option value lost by the managers of the network by virtue of their having committed their inventory to a particular campaign or campaigns early on in a planning cycle. Conversely, it might also be desirable to grant a discount to strategic partners or users of a network, in exchange for the volume of inventory they seek to reserve and/or purchase, and the duration over which they wish to use it. Similarly, inventory being bought on short notice might be heavily discounted, if network managers deem there are no better alternatives for its use—or alternately, sold at a premium, in return for the privilege of being allowed to book a campaign at the last moment.

In some embodiments, the inventory rate card generation module 115 acts as an auction, where users input bids for network inventory. The rate card generation module and inventory avails module systems may communicate with one another, such that both inventory avails and rate cards automatically update in accordance with each other's respective status. For example, a robust bidding environment might both “raise the bar” required for subsequent bids to win inventory, as well as resulting in the booking or reservation of inventory for campaigns with winning bids, deprecating the remaining avails. Similarly, an excess of available inventory might depress rate card pricing.

In another embodiment, the pricing guidelines and rules themselves become a function of network audience size or characteristics, and/or past, present, or expected future campaign performance on the inventory types in question. For example, consider a network of media devices employed in a retail environment (e.g., grocery, mass retail, finance, etc.), in which at least a partial goal of those utilizing the network for their campaigns is to drive some direct purchase or other short-term behavioral response on the part of the audience consuming the media. In such a situation, it is likely that the magnitude and composition of the audience will itself vary over time (by daypart, day of week, season, holiday, week of the year, etc.). In such a case, the inventory will have a different intrinsic value, as audience size and/or responsiveness to the media changes over time. This difference in value could be expressed in general terms, as when the rate card generation module returns the same pricing guidelines for inventory irrespective of the details of any particular campaign, or it could be made idiosyncratic to one or a set of specific campaigns, as when the rate card generation module returns different pricing guidelines for campaigns that are expected to perform better than for those expected to perform worse when executed on the same inventory. For example, network managers of a retail media network may wish to charge a different price depending on audience exposure, reach and frequency, various audience behavioral response, or the expected performance of the campaign in terms of incremental sales of the item or items featured in the campaign, or of the category those featured items belong to, or even depending on the marginal rate of return on the sales of those items.

Finally, the rate card generation module 115 prepares the calculated and/or predetermined pricing guidelines for delivery. For example, rate cards (including the latest bids) may be formatted and distributed to users via a user interface, or made available as inputs to another system in the form of a data feed.

### V. Scheduling Module

The inventory parameterization module, inventory avails module, and inventory rate card generation module (as well as additional systems and processes detailed in the U.S. patent applications that were incorporated by reference, most notably performance measurement and performance optimization systems) have an impact on the scheduling logic and rules that dictate the behavior of the network. More specifically, these modules and systems have the potential to increase greatly the complexity of the scheduling logic for the network or networks of media devices to which they pertain.

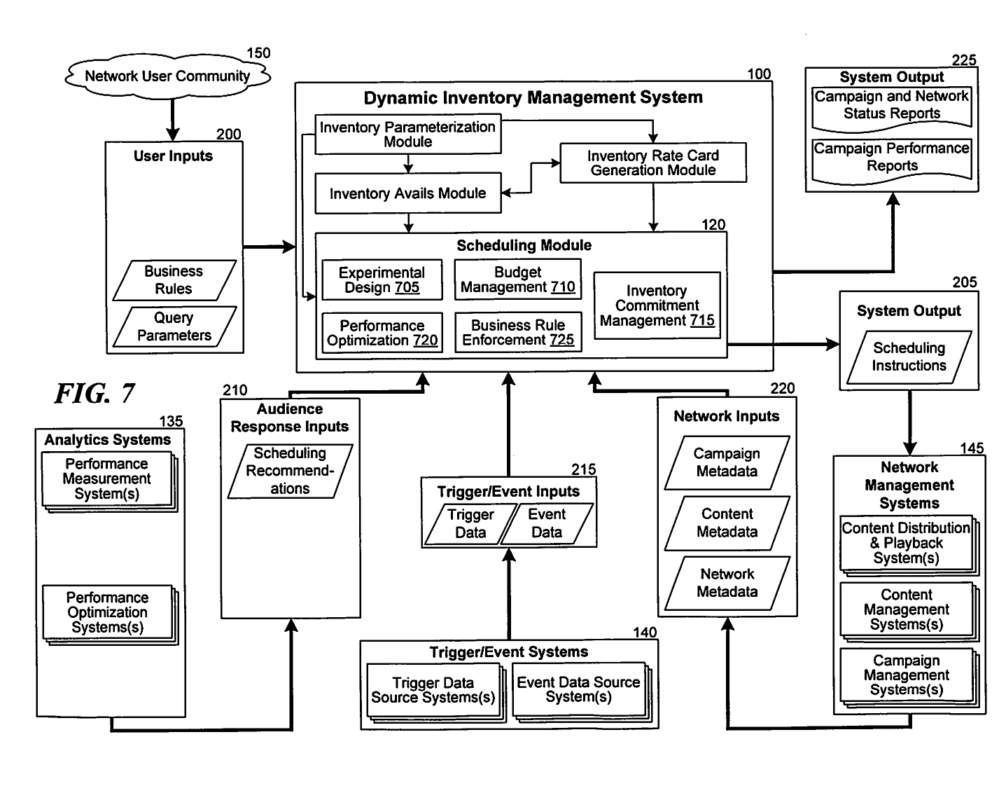

A scheduling module 120 may therefore be provided in the dynamic inventory management system 100 for the automated generation of scheduling instructions—both to meet the requirements of this greater scheduling complexity, and also to enable the modules described here to act in a third party capacity in interfacing with existing content distribution systems (for example, to act as an independent scheduling agent). FIG. 7 is a block diagram of the dynamic inventory management system 100 with certain inputs, outputs, and connected systems highlighted that are utilized by the scheduling module 120 to generate scheduling instructions. Depending on the particular embodiment, some or all of the particular inputs shown in FIG. 7 may be utilized; not every embodiment requires all data inputs, depending on the nature of the underlying network and the specific requirements of the scheduling system. Other inputs that are not shown may also be used by the dynamic inventory management system to generate scheduling instructions.

The scheduling module 120 collects data from a number of different sources to enable it to generate scheduling instructions. For example, the scheduling module 120 may receive business rules constraining the scheduling process and/or input query parameters from users of the system (e.g., network programming planners, ad sales teams, store managers, other systems, etc.) via user inputs 200. Such user inputs may be received via user interfaces and/or application programming interfaces.

The scheduling module 120 also collects inventory data and metadata from the inventory parameterization module 105. The inventory data and metadata is used to define the granularity with which the scheduling module will make decisions and in guiding the scheduling instructions that the scheduling module will produce. Data are also collected from the inventory avails module 110. These data may include calculations of future amounts of deterministic inventory types, as well as forecasted future amounts for stochastic inventory types.

The scheduling module 120 also collects scheduling recommendations from one or many analytics systems 135. For example, the scheduling recommendations might be used to ensure that the scheduling module is able to capture and enforce underlying experimental designs or other scheduling requirements required to support a performance measurement system, as when a campaign or its individual treatments are being deliberately excluded in certain times and places in order to provide a control period used as part of the assessment of a campaign's performance (further descriptions of a performance measurement system, and the specific requirements they impose on the creation of schedules, may be found in the related U.S. applications that have been incorporated by reference herein). In similar fashion, scheduling recommendations might be used to ensure that the scheduling module is able to capture and enforce underlying experimental designs or other scheduling requirements required to support a performance optimization system.

The scheduling module 120 also collects metadata and/or data feeds from one or many source systems 140 for triggers and events. Finally, the scheduling module collects campaign, content, and other network metadata from one or many network management systems 145. The campaign, content, and other network data provides the scheduling module with visibility into inventory commitments and other constraints associated with campaigns, as well as the relationship between campaigns and their treatments, and between treatments and individual content items.

As depicted in FIG. 7, the scheduling module 120 may execute one or more processes in the generation of schedules. These are shown as five component processes, namely an experimental design process 705 (which may constrain when and where certain campaigns and/or treatments have their content items included in the scheduling), a budget management process 710 (which may constrain total inventory allocation to a given campaign), an inventory commitment management process 715 (which may force certain patterns or amounts of inventory allocations to campaigns and/or treatments, as well as constraining where campaigns and/or their treatments may or may not be included at all, as when campaigns have been targeted against some subset of the total network inventory; since inventory means both stochastic and deterministic inventory types, that trigger and event data may play a role as well in allocation), a performance optimization process 720 (which may cause the module to make one potential allowable choice of inventory allocation over another, to maximize campaign or network performance), and a business rules enforcement process 725 (which may, among other things, control adjacencies of campaigns, treatments, or content items, expressly prevent or require co-occurrence of particular campaigns and treatments, etc.).

The specific logic and goals underlying allocation decisions made by the scheduling module 120 may vary. For example, if one component of scheduling is the support of an experimental design conducive to performance measurement, the scheduling module may be constrained to expressly exclude certain treatments from certain prescribed inventory. Similarly, if the treatments in question have specific inventory commitments associated with them (i.e., the treatments must be played in certain times and places, or receive at least some minimal total allocation of inventory), the scheduling module will be constrained to uphold those commitments. Additionally, it may be the case that part of the goal of the scheduling module is to optimize the performance of some or all treatments, ad revenue, etc., in which case the final allocation of inventory to treatments will in all or in part reflect those global or localized optimization goals.

Just as there are many specific business rules and constraints that the scheduling module may be required to uphold, and many different objectives it may seek to satisfy, so also are there multiple specific algorithmic approaches that may be employed to arrive at a final set of treatment/inventory allocation decisions. For example, the scheduling module may be configured to proceed in a sequential fashion, first imposing the requirements of an underlying experimental design in support of performance measurement, then satisfying inventory guarantees and commitments to specific treatments, and then allocating remaining inventory on a performance optimizing basis. Alternatively, the scheduling module may employ some form of constrained (or unconstrained), linear or non-linear optimization to produce a single optimal allocation in one step that satisfies all these potentially competing objectives simultaneously. Alternatively, the scheduling module may proceed in an iterative fashion, first considering one inventory allocation, and then attempting to converge on some better final set of inventory allocation decisions through successive evaluation of alternatives, perhaps employing techniques and tools from the fields of neural networks, genetic algorithms, genetic programming, simulated annealing, matching algorithms or other tools or approaches from the broader field of game theory, or some other form of machine learning.

Once the scheduling instructions or rules have been generated by the scheduling module 120, the instructions and/or rules are prepared for delivery to the network management systems 145 (for example, to be distributed via a localized central controller, cached directly on media playback devices “in the field”, etc.). The scheduling instructions may be formatted in a manner specified by a particular network management system where they will be utilized to control the distribution of marketing campaigns. For example, in generating scheduling instructions or rules, it may be the case that the granularity of some or all of the decision making within the scheduling module 120 will result in a set of desired scheduling outcomes that cannot be readily understood by a content distribution system. For example, the scheduling module may enforce inventory commitments, meet the needs of measurement, adopt performance optimization recommendation, etc., all at the level of campaigns, treatments, and inventory types, whereas the content distribution system may require instructions that dictate much more precisely where and when particular content items should and should not be included in the playlist. Indeed, objects such as campaigns, treatments, inventory types, inventory commitments, etc., may not have any direct analogy in the content distribution system at all. In such cases, a multi-phased process may be implemented by the scheduling module to translate campaigns, treatments, etc. into detailed instructions that are suitable for the content distribution system. The multi-phased process first works through the scheduling decision-making logic described above before translating the desired set of scheduling outcomes into a granularity and precision of scheduling instruction or rule that the content distribution system can readily “understand” (e.g., to make appropriate determinations).

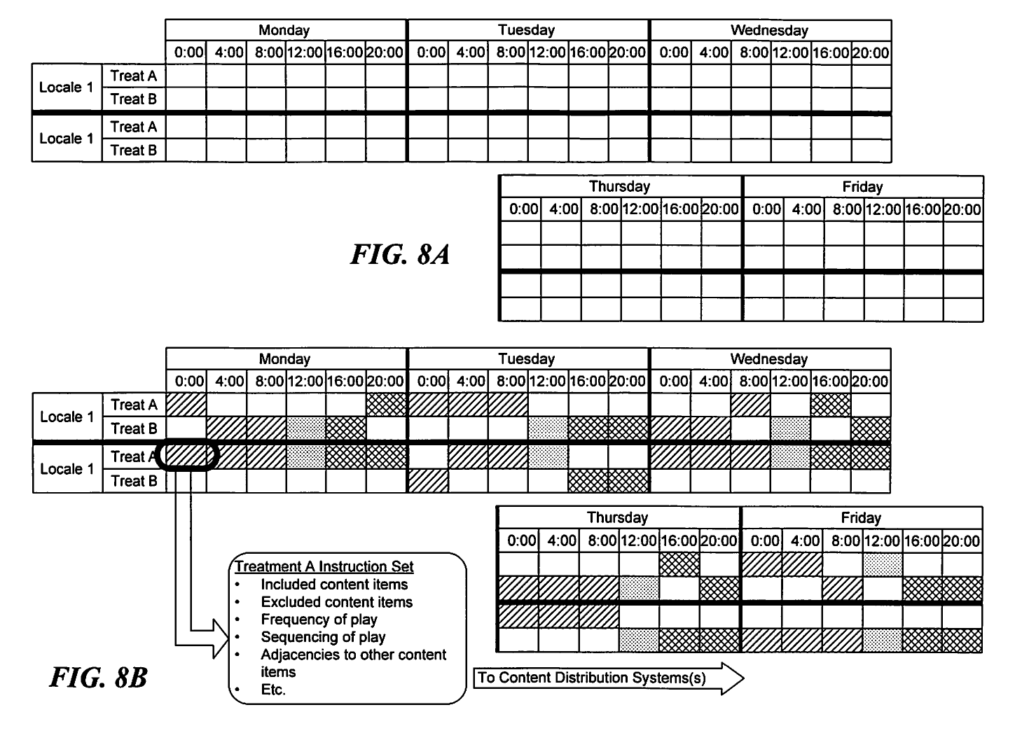

To further clarify the multi-phased scheduling process, FIGS. 8A and 8B illustrates such a multi-phased approach to the generation of scheduling instructions. FIG. 8A depicts a subset of inventory on a hypothetical network. Two locales (Locale 1 and Locale 2) are considered, along with five individual days (Monday through Friday; specific dates are not specified in the example, to keep the discussion generic). Moreover, the individual days have been subdivided into three discrete dayparts—conceptually, morning, afternoon, and evening. In the example, the scheduling module is tasked with generating a set of scheduling instructions for the content items associated with two different treatments (A and B), running on the network. These treatments may belong to the same or different campaigns; it makes no difference for sake of the example.

The scheduling module begins to construction scheduling instructions by making set or treatment-based allocation decisions of the available inventory. FIG. 8A illustrates the inventory in an unallocated state. This example presupposes that in any given locale, at any given time, there are sufficient inventory avails to accommodate one but not both treatments. Moreover, it is presupposed that the goal of the scheduling module is to always assign one treatment, though this need not be the case in more complicated examples.

FIG. 8B illustrates one possible choice of treatment allocations. In the example, although the daypart inventory types may span any period of time, the scheduling module has been configured to make allocation decisions at a temporal granularity of four hour blocks. For example, Treatment A will be scheduled to play on Monday from 0:00 to 4:00 in Locale 1 (that is, for the first block of time on that day), whereas Treatment B will play on Monday in Locale 1 for the remainder of the morning daypart (4:00 to 12:00) (that is, for the remaining two blocks of time that comprise the morning).

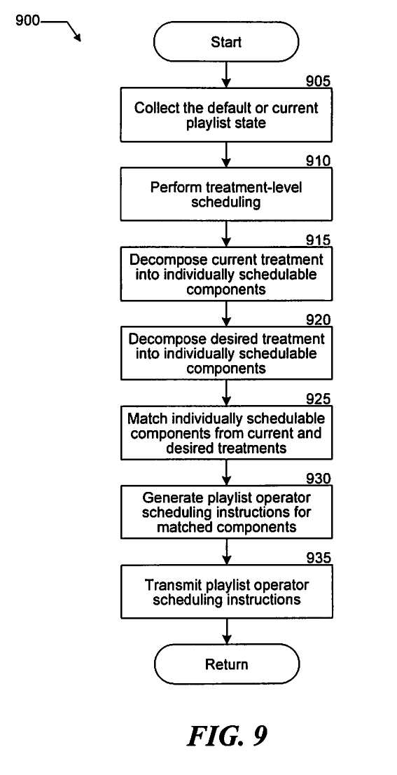

The scheduling module 120 is capable of mapping or translation the coarse inventory allocation illustrated in FIG. 8B to more detailed scheduling instructions of a type that can be consumed by systems responsible for content distribution and scheduling execution on the network. FIG. 9 is a flow chart of a process 900 implemented by the scheduling module 120 to convert coarse inventory allocation to granular scheduling instructions. In this embodiment, scheduling instructions are constructed in such a fashion as to alter an existing, default state of the content distribution system to meet the desired ends. In other words, the process 900 presumes a default or existing set of scheduling instructions or rules (i.e., a default playlist, playlists, or other instruction set dictating what content items are to appear where, when, under what conditions, etc.) are already configured in the content distribution system or systems, and modifies that default set appropriately. This need not be the case; in another embodiment, the content distribution system(s) would be programmed de novo by the scheduling module.

At a block 905, the scheduling module collects the default or current playlist state, perhaps from one or many content distribution systems or perhaps from some other source responsible for tracking the default/current state of what is scheduled (note that this information may even be held within the scheduling module itself). At a block 910, the scheduling module proceeds with the generation of treatment-level (i.e., set-based) inventory allocation, as in the manner described with respect to FIG. 8. Note that the ordering of the depicted steps may vary; FIG. 9 illustrates one particular fashion in which the scheduling module might proceed. For each unit of inventory to be scheduled, at a block 915 the scheduling module decomposes the currently scheduled/default treatments into their underlying, individually schedulable components (e.g., content items). The processing at block 915 may be skipped if the information in the default or current playlist state is already expressed in terms of individually schedulable content items, as opposed to sets of those content items (e.g., treatments). At a block 920, the scheduling module decomposes the desired treatments to be scheduled against each unit of inventory. Next, at a block 925, the scheduling module matches the existing and desired schedulable elements against one other. The matching may take many forms, including one-to-one (i.e., a single existing content item is paired with a single content item desired for scheduling), one-to-many, many-to-one, one-to-none, many-to-none, none-to-one, or none-to-many. At a block 930, the scheduling module then creates a series of instructions that dictate how the content distribution system(s) will modify their existing state to transition from the inclusion of the first element, set of elements, or null elements, to the second, desired element, set of elements, or null elements, for each matched set. Finally, at a block 935, the scheduling module passes the created instructions to the content distribution system(s) for implementation and execution.

One advantage of process 900 is that it provides an abstraction between the logic of inventory allocation and the final set of granular scheduling instructions which instantiate those allocation decisions. Because the scheduling module is able to perform a translation between set- or treatment-based inventory allocation decisions and a final set of scheduling instructions, a level of complexity can be abstracted away from the decision-making elements of the dynamic inventory management system described herein.

Those skilled in the art will appreciate that the dynamic inventory management system 100 disclosed herein may be implemented on any computing system or device. Suitable computing systems or devices include personal computers, server computers, hand-held or laptop devices, multiprocessor systems, microprocessor-based systems, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

From the foregoing, it will be appreciated that specific embodiments of the invention have been described herein for purposes of illustration, but that various modifications may be made without deviating from the invention. Accordingly, the invention is not limited except as by the appended claims.

I/We claim:

1. A system for the scheduling of available advertising inventory on a plurality of digital media devices that are sited at public locations, the system comprising:
a parameterization module that receives data associated with a plurality of inventory units, each of the plurality of inventory units reflecting a time during which one or more content items may be presented on a corresponding one of a plurality of digital media devices that are sited at public locations, the parameterization module characterizing the plurality of inventory units based on the received data;
an availability module that receives a desired inventory type and time period for a marketing campaign comprised of one or more content items, the availability module comparing the received desired inventory type and time period with the characterized plurality of inventory units generated by the parameterization module in order to identify available inventory units that satisfy the desired inventory type and time period, wherein the availability module takes into account deterministic inventory commitments made against the plurality of inventory units when identifying available inventory units; and
a scheduling module for automatically generating scheduling instructions to cause the marketing campaign to be presented during the identified available inventory units.

2. The system of claim 1, wherein the availability module further takes into account stochastic inventory commitments made against the plurality of inventory units when identifying available inventory units.
